(19) United States
(12) Patent Application Publication
(10) Pub. No.: US 2017/0127787 A1
(43) Pub. Date: May 11, 2017

(54) PACKAGED SHAVING PRODUCT

(71) Applicant: The Gillette Company, Boston, MA (US)

(72) Inventors: Sushant Trivedi, Boston, MA (US); Jacqueline Amos Gagas, Chestnut Hill, MA (US)

(21) Appl. No.: 15/232,007

(22) Filed: Aug. 9, 2016

Related U.S. Application Data
(60) Provisional application No. 62/251,180, filed on Nov. 5, 2015.

(51) Int. Cl. A45D 27/22; B26B 21/44; B65D 75/32; B26B 21/22

(52) U.S. Cl. CPC A45D 27/225; B26B 21/222; B26B 21/446; B65D 75/322

(57) ABSTRACT

A packaged shaving product including a razor handle connectable in use with a razor blade cartridge. A single use disposable blister package encloses only the razor handle.

### FIELD OF THE INVENTION

The present invention relates to packaged consumer goods, and more particularly to a packaged shaving product.

### BACKGROUND OF THE INVENTION

Disposable blister-type packages are popular for storing and displaying articles for sale. The primary components of a disposable blister-type pack are the outer shells made from a formable transparent material, e.g., plastic, and the cavity or pocket created between the outer shells. The formed cavity or pocket contains the product and the outer shells seal the product within the cavity. The consumer can easily examine the product through the transparent plastic. The plastic shell is vacuum-formed around a mold. The pre-formed plastic shells are affixed to another using heat and pressure to activate an adhesive. The adhesive is strong enough so that the package may hang on a peg to be displayed.

Single use disposable blister packs are typically thermoformed. Thermoforming is a manufacturing process where a plastic sheet is heated to a pliable forming temperature, formed to a specific shape in a mold, and trimmed to create a usable product. The sheet (or film when referring to thinner gauges and certain material types), is heated in an oven to a high-enough temperature that it can be stretched into or onto a mold and cooled to a finished shape. For high-volume applications, very large production machines are utilized to heat and form the plastic sheet and trim the formed parts from the sheet in a continuous high-speed process, and can produce many thousands of finished parts per hour depending on the machine and mold size and the size of the parts being formed.

Single use disposable blister packages have the advantage of offering a very attractive solution to display a package allowing the consumer to view the product within the package. Single use disposable blister packages have been used to enclose a razor handle and cartridge(s). Razor handles and cartridges are sold as kits and packaged together within disposable blister packages. Such kits have the advantage of providing the consumer with a ready to shave option upon opening the disposable blister package containing both a razor handle and razor cartridge. However, such kits limit the user's options where razor handles having different operative effects can be connectable in use with the same cartridges.

There is a desire to overcome the problem associated with such single use disposable blister packages enclosing both the razor handle and razor cartridge by enclosing only the razor handle within the single use disposable blister package. Such a package provides the user with an unlimited independent selection of both razor handle and razor cartridges.

### SUMMARY OF THE INVENTION

The present invention relates to a packaged shaving product. The packaged shaving product comprises a razor handle connectable in use with a razor blade cartridge, and a single use disposable blister package enclosing only the razor handle.

The disposable blister package comprises a transparent surface. The razor handle comprises a connection structure for connecting the razor handle with a razor blade cartridge. The present invention relates to a system of shaving products. The system of shaving products comprises a first razor handle connectable in use with a razor blade cartridge. The first razor handle is configured to provide a first operative effect. The first razor handle is enclosed in a first single use disposable blister package and arranged at a first position. The first single use disposable blister package encloses only the first razor handle. The system of shaving products comprises a second razor handle connectable in use with a razor blade cartridge. The second razor handle is configured to provide a second operative effect, different from the first operative effect. The second razor handle is enclosed in a second single use disposable blister package and arranged at a second position. The second single use disposable blister package encloses only the second razor handle. The first and second positions are located in a mutually distal manner along a first system axis.

The first system axis may be vertical. Alternatively, the first system axis may be horizontal.

The system of shaving products may be displayed on a wall. The system may be displayed on a computer monitor, video monitor, mobile phone and the like.

The first operative effect may comprise physical movement such as pivoting and rotating. The first operative effect may comprise no physical movement such as no pivoting and no rotating. The first operative effect may be the application of cooling or heating. The first operative effect may be the dispensing, delivery or application of fluid such as a shave preparation or lotion. The first operative effect may be vibration.

The second operative effect may comprise physical movement such as pivoting or rotating. The second operative effect may comprise no physical movement such as no pivoting and no rotating. The second operative effect may be the application of cooling or heating. The second operative effect may be the dispensing, delivery or application of fluid such as a shave preparation or lotion. The second operative effect may be vibration.

The system may comprise a razor blade cartridge in a razor blade cartridge package. The razor blade cartridge is connectable in use with each of the first razor handle and the second razor handle.

The system may comprise a second razor blade cartridge in a second razor blade cartridge package. The second razor blade cartridge is connectable in use with each of the first razor handle and the second razor handle. The second razor blade cartridge is different from the first razor blade cartridge.

The system may comprise a third razor blade cartridge in a third razor blade cartridge package. The third razor blade cartridge is connectable in use with each of the first razor handle and the second razor handle. The third razor blade cartridge is different from the first and second razor blade cartridges.

The present invention relates to a method of selecting from a system of physical shaving products. The system comprises a first razor handle connectable in use with a razor blade cartridge. The first razor handle is configured to provide a first operative effect. The first razor handle is enclosed in a first single use disposable blister package and arranged at a first position. The first single use disposable blister package encloses only the first razor handle. The system comprises second razor handle connectable in use with a razor blade cartridge. The second razor handle is configured to provide a second operative effect, different from the first operative effect. The second razor handle is enclosed in a second single use disposable blister package and arranged at a second position. The second single use disposable blister package encloses only the second razor handle. The system comprises a razor blade cartridge in a razor blade cartridge package. The razor blade cartridge is connectable in use with each of the first razor handle and the second razor handle. The method comprises selecting one of the first or the second single use disposable blister package, and selecting the razor blade cartridge.

The first operative effect may comprise physical movement such as pivoting and rotating. The first operative effect may comprise no physical movement such as no pivoting and no rotating. The first operative effect may be the application of cooling or heating. The first operative effect may be the dispensing, delivery or application of fluid such as a shave preparation or lotion.

The second operative effect may comprise physical movement such as pivoting or rotating. The second operative effect may comprise no physical movement such as no pivoting and no rotating. The second operative effect may be the application of cooling or heating. The second operative effect may be the dispensing, delivery or application of fluid such as a shave preparation or lotion.

The method comprises selecting one of the first or the second single use disposable blister package, and selecting one of the razor blade cartridge package or the second razor blade cartridge package.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a front plan view of a packaged shaving product of the present invention.

FIG. 2 is a back plan view of the packaged shaving product of FIG. 1.

FIG. 3 is a cross-sectional view of the packaged shaving product of FIG. 1 taken along section line 3-3.

FIG. 4 is a front plan view of a system of shaving products.

FIG. 5 is a front plan view of a system of shaving products.

FIG. 6 is a front plan view of a system of shaving products.

FIG. 7 is a plan view of razor blade cartridges.

FIG. 8 is a plan view of razor blade cartridges.

FIG. 9 is a plan view of razor blade cartridges.

### DETAILED DESCRIPTION OF THE INVENTION

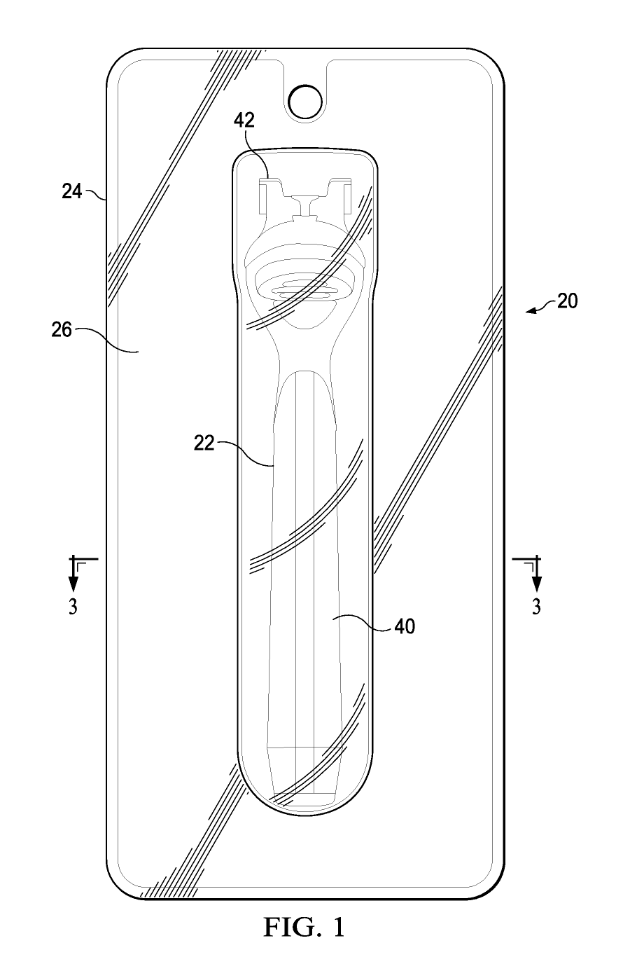

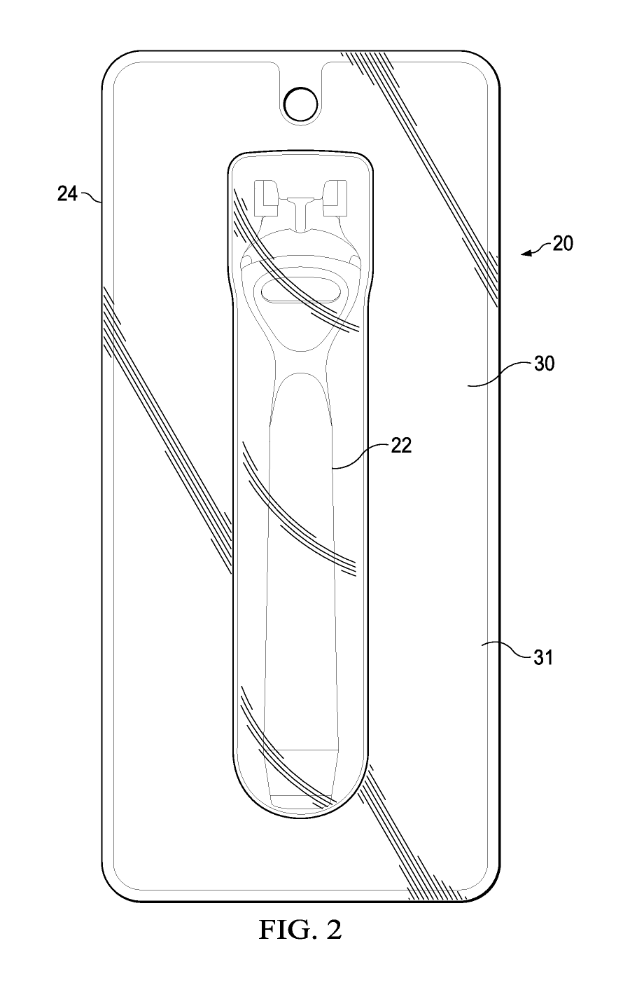

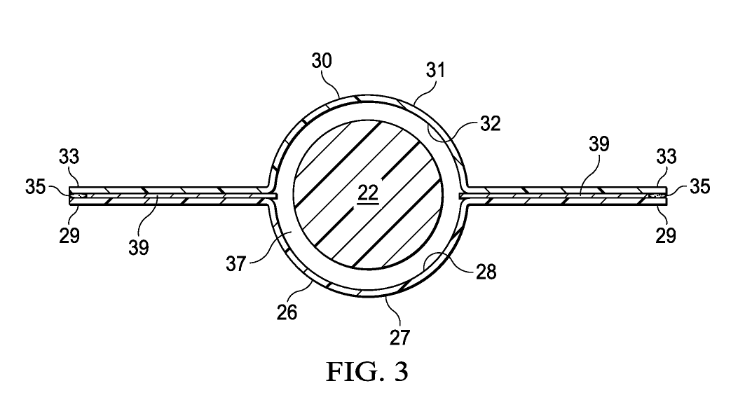

Referring to FIGS. 1-3, there is shown a packaged shaving product 20 of the present invention. The packaged shaving product 20 comprises a razor handle 22 connectable in use with a razor blade cartridge (not shown), and a single use disposable blister package 24 enclosing only the razor handle 22.

The single use disposable blister package 24 includes a front member 26 and a back member 30. Front member 26 has a first or outer surface 27, an opposing second or inner surface 28 and a front flange 29 extending around the periphery of front member 26.

Back member 30 has a first or outer surface 31, an opposing second or inner surface 32 and a back flange 33 extending around the periphery of back member 30.

A joint 35 secures the front flange 29 to the back flange 33. The joint 35 may be a heat seal, pressure seal, adhesive, or mechanical engagement securing the front flange 29 to the back flange 33. A cavity 37 is located between the front member 26 and the back member 30 and more particularly between the inner surface 28 of the front member 26 and the inner surface 32 of the back member 30. The razor handle 22 resides within the cavity 37.

The front member 26 and the back member 30 may be formed from plastic. The front member 26 and back member 30 may be manufactured from generally translucent or transparent polymers such that consumers can view the razor handle within the single use disposable blister package 24. Opaque materials such as wood/paper pulp or Styrofoam may even be used if transparency is not required for either the front member 26 or back member 30 or both. Examples of transparent or translucent polymers may include, but are not limited to polyolefins (e.g., polypropylene, high density polyethylene or low density polyethylene), polyesters (e.g., polyethylene terephthalate), and poly vinyl chloride (PVC). The front and back members may be produced by thermoforming or other known processing methods such as injection molding, blow molding, cold forming, and injection blow molding.

The razor handle 22 comprises a grip portion 40 and a connection structure 42 for connecting the razor handle 22 with a razor blade cartridge.

The single use disposable blister package 24 also includes a card 39 between front member 26 and a back member 30.

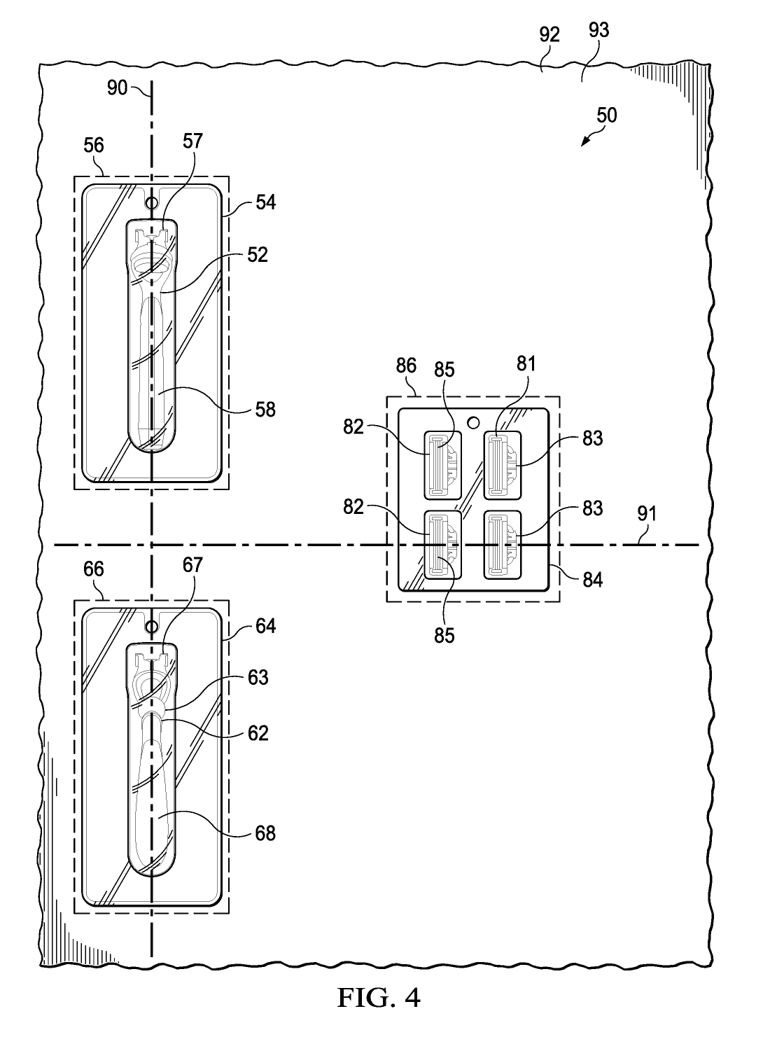

Referring now to FIG. 4 there is shown a system of shaving products 50. The system of shaving products 50 comprises a first razor handle 52 connectable in use with a razor blade cartridge. The first razor handle 52 comprises a cartridge connection structure 57 to connect in use first handle 52 with a razor blade cartridge. The first razor handle 52 comprises a grip portion 58 allowing the user to grip the first razor handle 52 in use. The first razor handle 52 is configured to provide a first operative effect. The first razor handle 52 is enclosed in a first single use disposable blister package 54 and arranged at a first position 56. The first single use disposable blister package 54 encloses only the first razor handle 52. That is, the first single use disposable blister package 54 does not include any razor blade cartridges.

The system of shaving products 50 comprises a second razor handle 62 connectable in use with a razor blade cartridge. The second razor handle 62 comprises a cartridge connection structure 67 to connect in use second handle 62 with a razor blade cartridge. The second razor handle 62 comprises a grip portion 68 allowing the user to grip the second razor handle 62 in use. The second razor handle 62 is configured to provide a second operative effect, different from the first operative effect. The second razor handle 62 is enclosed in a second single use disposable blister package 64 and arranged at a second position 66. The second single use disposable blister package 64 encloses only the second razor handle 62. That is, the second single use disposable blister package 64 does not include any razor blade cartridges.

The first and second positions, 56 and 66, are located in a mutually distal manner along a first system axis 90. In the system of shaving products 50 the first system axis 90 is oriented in a vertical manner. With a vertical first system axis 90, the first position 56 is positioned vertically above the second position 66.

The system of shaving products 50 preferably includes a razor blade cartridge 82 connectable in use with each the first razor handle 52 and the second razor handle 62. The razor blade cartridges 82 comprises a housing 81, at least one blade 85 within housing 81 and a handle connection structure 83 to connect in use razor blade cartridge 82 with each first cartridge connection structure 57 and second cartridge connection structure 67.

The razor blade cartridge 82 is enclosed in a single use disposable razor blade cartridge package 84 and arranged at a third position 86. The single use disposable razor blade cartridge package 84 encloses only razor blade cartridges 82. That is, the single use disposable razor blade cartridge package 84 does not include any razor blade handles. The single use disposable razor blade cartridge package 84 is shown with four razor blade cartridges 82. The single use disposable razor blade cartridge package 84 may contain other amounts of razor blade cartridges 82 such as 1, 2, 3, 6, 8, 10, etc.

The third position 86 is located in a mutually distal manner along a second system axis 91. In the system of shaving products 50 the second system axis 91 is oriented in a horizontal manner. With a horizontal second system axis 91, the third position 86 is positioned horizontally next to or beside first position 56 and second position 66.

The system of shaving products 50 may be displayed on a wall 92. The system of shaving products 50 may be displayed on other structures such as shelving, displays, and peg boards. The system of shaving products 50 may be also displayed digitally such as on a mobile phone, television, or monitor such as a computer monitor and the like 93.

The first operative effect may comprise physical movement such as pivoting and rotating. The first operative effect may comprise no physical movement such as no pivoting and no rotating. The first operative effect may be the application of cooling or heating. The first operative effect may be the delivery, dispensing, or application of fluid such as a shave preparation or lotion. The first razor handle 52 is configured to provide a first operative effect of no physical movement.

The second operative effect may comprise physical movement such as pivoting or rotating. The second operative effect may comprise no physical movement such as no pivoting and no rotating. The second operative effect may be the application of cooling or heating. The second operative effect may be the delivery, dispensing, or application of fluid such as a shave preparation or lotion. The second razor handle 62 is configured to provide a second operative effect of rotating via rotating portion 63.

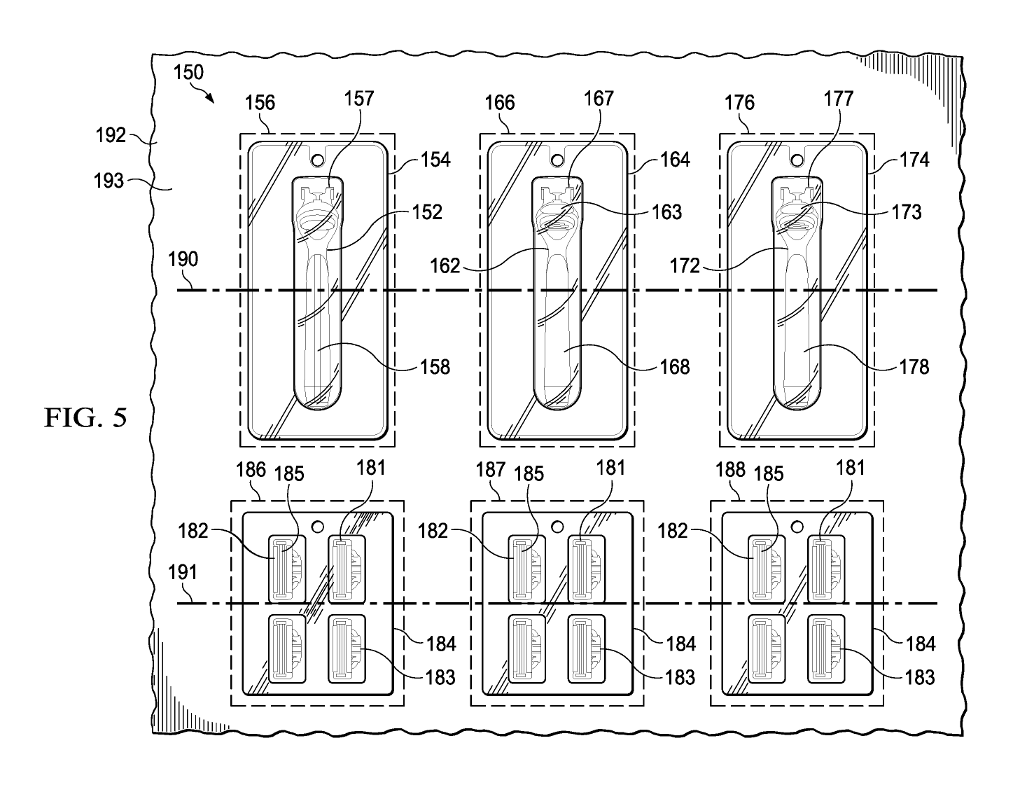

Referring now to FIG. 5 there is shown a system of shaving products 150. The system of shaving products 150 comprises a first razor handle 152 connectable in use with a razor blade cartridge. The first razor handle 152 comprises a cartridge connection structure 157 to connect in use first handle 152 with a razor blade cartridge. The first razor handle 152 comprises a grip portion 158 allowing the user to grip the first razor handle 152 in use. The first razor handle 152 is configured to provide a first operative effect. The first razor handle 152 is configured to provide a first operative effect of no physical movement. The first razor handle 152 is enclosed in a first single use disposable blister package 154 and arranged at a first position 156. The first single use disposable blister package 154 encloses only the first razor handle 152. That is, the first single use disposable blister package 154 does not include any razor blade cartridges.

The system of shaving products 150 comprises a second razor handle 162 connectable in use with a razor blade cartridge. The second razor handle 162 comprises a cartridge connection structure 167 to connect in use second handle 162 with a razor blade cartridge. The second razor handle 162 comprises a grip portion 168 allowing the user to grip the second razor handle 162 in use. The second razor handle 162 is configured to provide a second operative effect, different from the first operative effect. The second razor handle 162 is configured to provide a second operative effect of cooling via cooling portion 163. The second razor handle 162 is enclosed in a second single use disposable blister package 164 and arranged at a second position 166. The second single use disposable blister package 164 encloses only the second razor handle 162. That is, the second single use disposable blister package 164 does not include any razor blade cartridges.

The system of shaving products 150 comprises a third razor handle 172 connectable in use with a razor blade cartridge. The third razor handle 172 comprises a cartridge connection structure 177 to connect in use third handle 172 with a razor blade cartridge. The third razor handle 172 comprises a grip portion 178 allowing the user to grip the third razor handle 172 in use. The third razor handle 172 is configured to provide a third operative effect, different from the first and second operative effects. The third razor handle 172 is configured to provide a third operative effect of heating via heating portion 173. The third razor handle 172 is enclosed in a third single use disposable blister package 174 and arranged at a third position 176. The third single use disposable blister package 174 encloses only the third razor handle 172. That is, the third single use disposable blister package 174 does not include any razor blade cartridges.

The first, second and positions, 156, 166 and 176, are located in a mutually distal manner along a first system axis 190. In the system of shaving products 150, the first system axis 190 is oriented in a horizontal manner. With a horizontal first system axis 190, the first position 156 is positioned horizontally next to or beside the second position 166 and the second position 166 is positioned horizontally next to or beside the third position 176.

The system of shaving products 150 preferably includes a razor blade cartridge 182 connectable in use with each the first razor handle 152, the second razor handle 162 and the third razor handle 172. The razor blade cartridges 182 comprise a housing 181, and a handle connection structure 183 to connect in use razor blade cartridge 182 with each first cartridge connection structure 157, second cartridge connection structure 167 and third cartridge connection structure 177. The razor blade cartridges 182 comprise at least one blade 185 within housing 181.

The razor blade cartridge 182 is enclosed in a single use disposable razor blade cartridge package 184 and arranged at a fourth position 186, fifth position 187 and sixth position 188. The single use disposable razor blade cartridge packages 184 enclose only razor blade cartridges 182. That is, the single use disposable razor blade cartridge packages 184 do not include any razor blade handles. The single use disposable razor blade cartridge packages 184 are shown with four razor blade cartridges 182. The single use disposable razor blade cartridge packages 184 may contain other amounts of razor blade cartridges 182 such as 1, 2, 3, 6, 8, 10, etc.

The fourth, fifth, and sixth positions, 186, 187 and 188, are located in a mutually distal manner along a second system axis 191. In the system of shaving products 150, the second system axis 191 is oriented in a horizontal manner. With a horizontal second system axis 191, the fourth position 186 is positioned horizontally next to or beside the fifth position 187 and the fifth position 187 is positioned horizontally next to or beside the sixth position 188. The second system axis 191 is positioned vertically below the first system axis 190. Preferably the first system axis 190 and the second system axis 191 are parallel with each other.

The system of shaving products 150 may be displayed on a wall 192. The system of shaving products 150 may be displayed on other structures such as shelving, displays, and peg boards. The system of shaving products 150 may be also displayed digitally such as on a mobile phone, television, or monitor such as a computer monitor and the like 193.

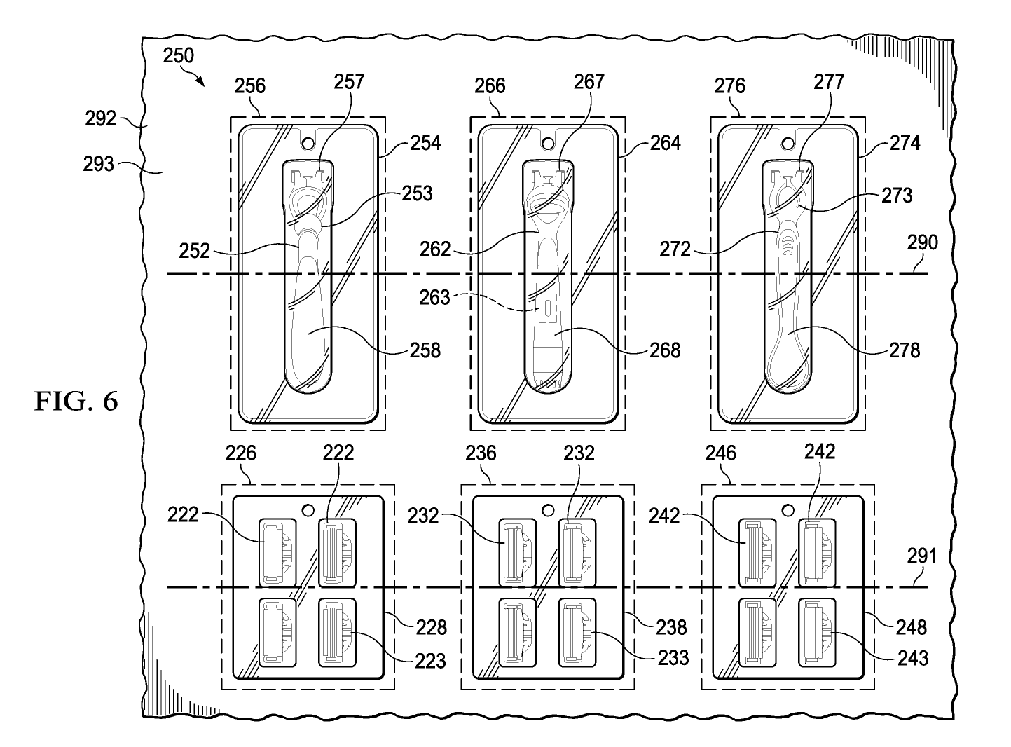

Referring now to FIG. 6 there is shown a system of shaving products 250. The system of shaving products 250 comprises a first razor handle 252 connectable in use with a razor blade cartridge. The first razor handle 252 comprises a cartridge connection structure 257 to connect in use first handle 252 with a razor blade cartridge. The first razor handle 252 comprises a grip portion 258 allowing the user to grip the first razor handle 252 in use. The first razor handle 252 is configured to provide a first operative effect. The first razor handle 252 is configured to provide a first operative effect of pivoting via pivoting portion 253. The first razor handle 252 is enclosed in a first single use disposable blister package 254 and arranged at a first position 256. The first single use disposable blister package 254 encloses only the first razor handle 252. That is, the first single use disposable blister package 254 does not include any razor blade cartridges.

The system of shaving products 250 comprises a second razor handle 262 connectable in use with a razor blade cartridge. The second razor handle 262 comprises a cartridge connection structure 267 to connect in use second handle 262 with a razor blade cartridge. The second razor handle 262 comprises a grip portion 268 allowing the user to grip the second razor handle 262 in use. The second razor handle 262 is configured to provide a second operative effect, different from the first operative effect. The second razor handle 262 is configured to provide a second operative effect of vibration via vibration motor 263. The second razor handle 262 is enclosed in a second single use disposable blister package 264 and arranged at a second position 266. The second single use disposable blister package 264 encloses only the second razor handle 262. That is, the second single use disposable blister package 264 does not include any razor blade cartridges.

The system of shaving products 250 comprises a third razor handle 272 connectable in use with a razor blade cartridge. The third razor handle 272 comprises a cartridge connection structure 277 to connect in use third handle 272 with a razor blade cartridge. The third razor handle 272 comprises a grip portion 278 allowing the user to grip the third razor handle 272 in use. The third razor handle 272 is configured to provide a third operative effect, different from the first and second operative effects. The third razor handle 272 is configured to provide a third operative effect of fluid delivery via fluid delivery portion 273. The third razor handle 272 is enclosed in a third single use disposable blister package 274 and arranged at a third position 276. The third single use disposable blister package 274 encloses only the third razor handle 272. That is, the third single use disposable blister package 274 does not include any razor blade cartridges.

The first, second and positions, 256, 266 and 276, are located in a mutually distal manner along a first system axis 290. In the system of shaving products 250, the first system axis 290 is oriented in a horizontal manner. With a horizontal first system axis 290, the first position 256 is positioned horizontally next to or beside the second position 266 and the second position 266 is positioned horizontally next to or beside the third position 276.

The system of shaving products 250 preferably includes razor blade cartridges 222, 232 and 242 each connectable in use with each the first razor handle 252, the second razor handle 262 and the third razor handle 272. The razor blade cartridges 222 comprise a handle connection structure 223 to connect in use razor blade cartridge 222 with each first cartridge connection structure 257, second cartridge connection structure 267 and third cartridge connection structure 277. The razor blade cartridges 232 comprise a handle connection structure 233 to connect in use razor blade cartridge 232 with each first cartridge connection structure 257, second cartridge connection structure 267 and third cartridge connection structure 277. The razor blade cartridges 242 comprise a handle connection structure 243 to connect in use razor blade cartridge 242 with each first cartridge connection structure 257, second cartridge connection structure 267 and third cartridge connection structure 277.

The razor blade cartridges 222 are enclosed in a single use disposable razor blade cartridge package 228 and arranged at a fourth position 226. The single use disposable razor blade cartridge package 228 encloses only razor blade cartridges 222. That is, the single use disposable razor blade cartridge package 228 does not include any razor blade handles. The single use disposable razor blade cartridge packages 228 are shown with four razor blade cartridges 222. The single use disposable razor blade cartridge packages 228 may contain other amounts of razor blade cartridges 222 such as 1, 2, 3, 6, 8, 10, etc.

The razor blade cartridges 232 are enclosed in a single use disposable razor blade cartridge package 238 and arranged at a fifth position 236. The single use disposable razor blade cartridge package 238 encloses only razor blade cartridges 232. That is, the single use disposable razor blade cartridge package 238 does not include any razor blade handles. The single use disposable razor blade cartridge packages 238 are shown with four razor blade cartridges 232. The single use disposable razor blade cartridge packages 238 may contain other amounts of razor blade cartridges 232 such as 1, 2, 3, 6, 8, 10, etc.

The razor blade cartridges 242 are enclosed in a single use disposable razor blade cartridge package 248 and arranged at a sixth position 246. The single use disposable razor blade cartridge package 248 encloses only razor blade cartridges 242. That is, the single use disposable razor blade cartridge package 248 does not include any razor blade handles. The single use disposable razor blade cartridge packages 248 are shown with four razor blade cartridges 242. The single use disposable razor blade cartridge packages 248 may contain other amounts of razor blade cartridges 242 such as 1, 2, 3, 6, 8, 10, etc.

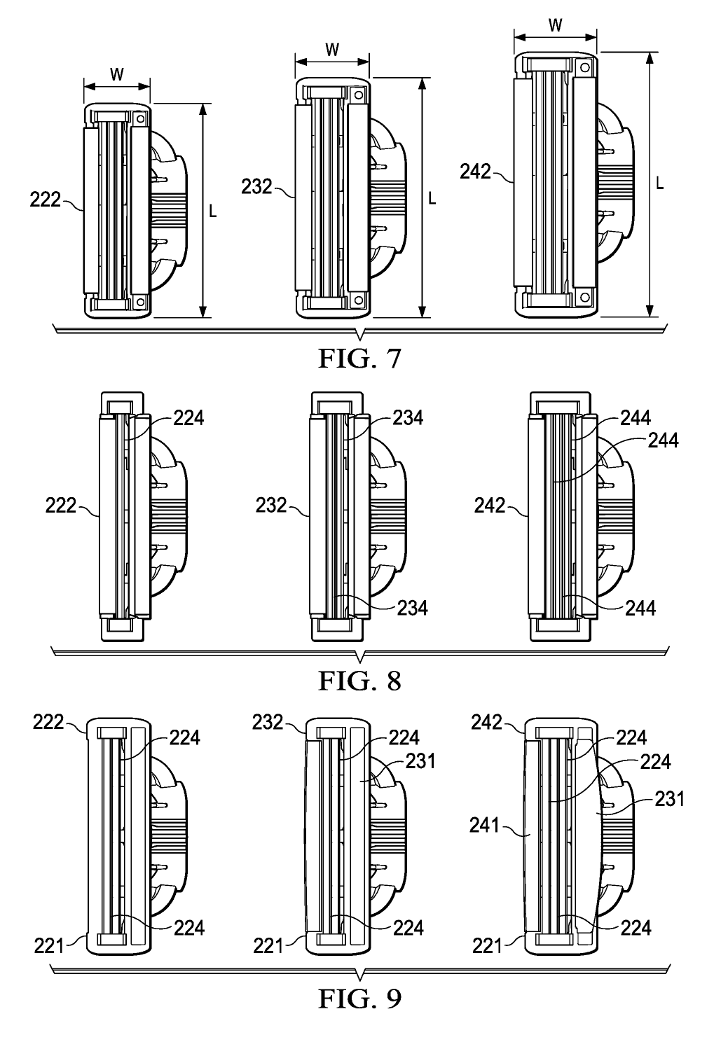

The razor blade cartridges 222, 232 and 242 are preferably physically different from one another. Referring now to FIG. 7, the razor blade cartridges 222, 232 and 242 may have different physical dimensions, such as length and/or width. For example, the first cartridge 222 may have the smallest physical length L and/or width W dimensions, the third cartridge 242 have the largest physical length L and/or width W dimensions and the second cartridge 232 may have medium physical length L and/or width W dimensions between the smallest and largest physical dimensions.

Referring now to FIG. 8, the razor blade cartridges 222, 232 and 242 may contain different number of blades. For example, first razor blade cartridge 222 may have one blade 224, second razor blade cartridge 232 may have two blades 234 and third razor blade cartridge 242 may have three blades 244.

Referring now to FIG. 9, the razor blade cartridges 222, 232 and 242 may have different features. For example, first razor blade cartridge 222 may have a housing 221 to hold the blades 224. Second razor blade cartridge 232 may be a similar housing 221 to hold blades 224 as cartridge 222 with the addition of an elastomeric guard 231 on the housing 221. Third razor blade cartridge 242 may be similar to second cartridge 232 with housing 221 holding blades 224, elastomeric guard 231 with the addition of a lubrication member 241.

Referring again to FIG. 6, the fourth, fifth, and sixth positions, 226, 236 and 246, are located in a mutually distal manner along a second system axis 291. In the system of shaving products 250, the second system axis 291 is oriented in a horizontal manner. With a horizontal second system axis 291, the fourth position 226 is positioned horizontally next to or beside the fifth position 236 and the fifth position 236 is positioned horizontally next to or beside the sixth position 246. The second system axis 291 is positioned vertically below the first system axis 290. Preferably the first system axis 290 and the second system axis 291 are parallel with each other.

The system of shaving products 250 may be displayed on a wall 292. The system of shaving products 250 may be displayed on other structures such as shelving, displays, and peg boards. The system of shaving products 250 may be also displayed digitally such as on a mobile phone, television, or monitor such as a computer monitor and the like 293.

Referring now to FIG. 4, the present invention relates to a method of selecting from a system of physical shaving products. The system of shaving products 50 comprises a first razor handle 52 connectable in use with a razor blade cartridge. The first razor handle 52 is configured to provide a first operative effect. The first razor handle 52 is enclosed in a first single use disposable blister package 54 and arranged at a first position 56. The first single use disposable blister package 54 encloses only the first razor handle 52. The system of shaving products 50 comprises second razor handle 62 connectable in use with a razor blade cartridge, The second razor handle 62 is configured to provide a second operative effect, different from said first operative effect. The second razor handle 62 is enclosed in a second single use disposable blister package 64 and is arranged at a second position 66. The second single use disposable blister package 64 encloses only the second razor handle 62. The system of shaving products 50 comprises a razor blade cartridge 82 in a single use disposable razor blade cartridge package 84. The razor blade cartridge 82 is connectable in use with each of the first razor handle 52 and the second razor handle 62. The method comprises selecting one of the first or the second single use disposable blister package, 54 or 64, and selecting the disposable single use razor blade cartridge package 84.

The first operative effect may comprise physical movement such as pivoting and rotating. The first operative effect may comprise no physical movement such as no pivoting and no rotating. The first operative effect may be the application of cooling or heating. The first operative effect may be the delivery, dispensing, or application of fluid such as a shave preparation or lotion. The first operative effect may be vibration.

The second operative effect may comprise physical movement such as pivoting or rotating. The second operative effect may comprise no physical movement such as no pivoting and no rotating. The second operative effect may be the application of cooling or heating. The second operative effect may be the delivery, dispensing, or application of fluid such as a shave preparation or lotion. The second operative effect may be vibration.

Referring now to FIG. 6, the present invention relates to a method of selecting from a system of physical shaving products. The system of shaving products 250 comprises a first razor handle 252 connectable in use with a razor blade cartridge. The first razor handle 252 is configured to provide a first operative effect. The first razor handle 252 is enclosed in a first single use disposable blister package 254 and arranged at a first position 256. The first single use disposable blister package 254 encloses only the first razor handle 252. The system of shaving products 250 comprises second razor handle 262 connectable in use with a razor blade cartridge. The second razor handle 262 is configured to provide a second operative effect, different from said first operative effect. The second razor handle 262 is enclosed in a second single use disposable blister package 264 and is arranged at a second position 266. The second single use disposable blister package 264 encloses only the second razor handle 262. The system of shaving products 250 comprises a first razor blade cartridge 222 in a first razor blade cartridge package 228. The first razor blade cartridge 222 is connectable in use with each of the first razor handle 252 and the second razor handle 262. The system of shaving products 250 comprises a second razor blade cartridge 232 in a second razor blade cartridge package 238. The second razor blade cartridge 232 is connectable in use with each of the first razor handle 252 and the second razor handle 262.

The method comprises selecting one of the first or the second single use disposable blister package, 254 or 264, and selecting one of the single use disposable razor blade cartridge package 228 or the second single use disposable razor blade cartridge package 238.

The system of shaving products 250 may comprise a third razor handle 272 connectable in use with a razor blade cartridge. The third razor handle 272 is configured to provide a third operative effect. The third razor handle 272 is enclosed in a third single use disposable blister package 274 and arranged at a third position 276. The third single use disposable blister package 274 encloses only the third razor handle 272.

The method comprises selecting one of the first, second or third single use disposable blister package, 254, 264, or 274 and selecting one of the single use disposable razor blade cartridge package 228 or the second single use disposable razor blade cartridge package 238.

The system of shaving products 250 may comprise a third razor blade cartridge 242 in a third single use disposable razor blade cartridge package 248. The third razor blade cartridge 242 is connectable in use with each of the first razor handle 252, the second razor handle 262 and the third razor handle 272.

The method comprises selecting one of the first, second or third single use disposable blister package, 254, 264, or 274 and selecting one of the single use disposable razor blade cartridge package 228 or the second single use disposable razor blade cartridge package 238 or the third single use disposable razor blade cartridge package 248.

### Combinations

A. A packaged shaving product comprising:

a razor handle connectable in use with a razor blade cartridge, and

a single use disposable blister package enclosing only said razor handle.
B. The packaged shaving product of Paragraph A wherein the single use disposable blister package comprises a transparent surface.
C. The packaged shaving product of Paragraphs A or B wherein the razor handle comprises a connection structure for connecting the razor handle with the razor blade cartridge.
D. A system of shaving products comprising:

a first razor handle connectable in use with a razor blade cartridge, said first razor handle configured to provide a first operative effect, said first razor handle being enclosed in a first single use disposable blister package and arranged at a first position, said first single use disposable blister package enclosing only said first razor handle; and

a second razor handle connectable in use with a razor blade cartridge, said second razor handle configured to provide a second operative effect, different from said first operative effect, said second razor handle being enclosed in a second single use disposable blister package and arranged at a second position, said second single use disposable blister package enclosing only said second razor handle;

said first and second positions being located in a mutually distal manner along a first system axis.
E. The system of Paragraph D, further comprising a razor blade cartridge in a razor blade cartridge package, said razor blade cartridge being connectable in use with each of said first razor handle and said second razor handle.
F. The system of Paragraphs D or E, wherein the first system axis is vertical or horizontal.
G. The system of any one of Paragraphs D through F, wherein the system of shaving products is displayed on a wall.
H. The system of any one of Paragraphs D through F, wherein the system of shaving products is displayed on a computer monitor.
I. The system of any one of Paragraphs D through H, wherein the first operative effect comprises physical movement, pivoting, rotating, no physical movement, cooling, heating, the delivery, dispensing or application of fluid and vibration.
J. The system of any one of Paragraphs D through H, wherein the second operative effect comprises physical movement, pivoting, rotating, no physical movement, cooling, heating, the delivery, dispensing or application of fluid and vibration.
K. A method of selecting from a system of physical shaving products, the method comprising:

a first razor handle connectable in use with a razor blade cartridge, said first razor handle configured to provide a first operative effect, said first razor handle being enclosed in a first single use disposable blister package and arranged at a first position, said first single use disposable blister package enclosing only said first razor handle;

a second razor handle connectable in use with a razor blade cartridge, said second razor handle configured to provide a second operative effect, different from said first operative effect, said second razor handle being enclosed in a second single use disposable blister package and arranged at a second position, said second single use disposable blister package enclosing only said second razor handle; and

a razor blade cartridge in a razor blade cartridge package, said razor blade cartridge being connectable in use with each of said first razor handle and said second razor handle; the method comprising:

selecting one of said first single use disposable blister package or said second single use disposable blister package; and,

selecting said single use disposable razor blade cartridge package.
L. The method of Paragraph K, wherein the first operative effect comprises physical movement, pivoting, rotating, no physical movement, cooling, heating, the delivery, dispensing or application of fluid and vibration.
M. The method of Paragraph K, wherein the second operative effect comprises physical movement, pivoting, rotating, no physical movement, cooling, heating, the delivery, dispensing or application of fluid and vibration.
N. The method of any one of Paragraphs K through M, further comprising a second razor blade cartridge in a second single use disposable razor blade cartridge package, and selecting one of said single use disposable razor blade cartridge package or said second single use disposable razor blade cartridge package.
O. The method of any one of Paragraphs K through N, further comprising a third razor handle connectable in use with a razor blade cartridge, said third razor handle configured to provide a third operative effect, different from said first operative effect and the second operative effect, said third razor handle being enclosed in a third single use disposable blister package and arranged at a third position, said third single use disposable blister package enclosing only said third razor handle;
   selecting one of said first, said second or said third single use disposable blister package; and,

selecting one of said single use disposable razor blade cartridge package, or said second single use disposable razor blade cartridge package.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A packaged shaving product comprising:
a razor handle connectable in use with a razor blade cartridge, and
a single use disposable blister package enclosing only said razor handle.

2. The packaged shaving product of claim 1 wherein the single use disposable blister package comprises a transparent surface.

3. The packaged shaving product of claim 1 wherein the razor handle comprises a connection structure for connecting the razor handle with the razor blade cartridge.

4. A system of shaving products comprising:
a first razor handle connectable in use with a razor blade cartridge, said first razor handle configured to provide a first operative effect, said first razor handle being enclosed in a first single use disposable blister package and arranged at a first position, said first single use disposable blister package enclosing only said first razor handle; and
a second razor handle connectable in use with a razor blade cartridge, said second razor handle configured to provide a second operative effect, different from said first operative effect, said second razor handle being enclosed in a second single use disposable blister package and arranged at a second position, said second single use disposable blister package enclosing only said second razor handle;
said first and second positions being located in a mutually distal manner along a first system axis.

5. The system of claim 4, further comprising a razor blade cartridge in a razor blade cartridge package, said razor blade cartridge being connectable in use with each of said first razor handle and said second razor handle.

6. The system of claim 4, wherein the first system axis is vertical.

7. The system of claim 4, wherein the first system axis is horizontal.

8. The system of claim 4, wherein the system of shaving products is displayed on a wall.

9. The system of claim 4, wherein the system of shaving products is displayed on a computer monitor.

10. The system of claim 4, wherein the first operative effect comprises physical movement, pivoting, rotating, no physical movement, cooling, heating, the delivery, dispensing or application of fluid and vibration.

11. The system of claim 4, wherein the second operative effect comprises physical movement, pivoting, rotating, no physical movement, cooling, heating, the delivery, dispensing or application of fluid and vibration.

12. A method of selecting from a system of physical shaving products, the method comprising:
a first razor handle connectable in use with a razor blade cartridge, said first razor handle configured to provide a first operative effect, said first razor handle being enclosed in a first single use disposable blister package and arranged at a first position, said first single use disposable blister package enclosing only said first razor handle;
a second razor handle connectable in use with a razor blade cartridge, said second razor handle configured to provide a second operative effect, different from said first operative effect, said second razor handle being enclosed in a second single use disposable blister package and arranged at a second position, said second single use disposable blister package enclosing only said second razor handle; and
a razor blade cartridge in a razor blade cartridge package, said razor blade cartridge being connectable in use with each of said first razor handle and said second razor handle; the method comprising:
selecting one of said first single use disposable blister package or said second single use disposable blister package; and,
selecting said single use disposable razor blade cartridge package.

13. The method of claim 12, wherein the first operative effect comprises physical movement, pivoting, rotating, no physical movement, cooling, heating, the delivery, dispensing or application of fluid and vibration.

14. The method of claim 12, wherein the second operative effect comprises physical movement, pivoting, rotating, no physical movement, cooling, heating, the delivery, dispensing or application of fluid and vibration.

15. The method of claim 12, further comprising a second razor blade cartridge in a second single use disposable razor blade cartridge package, and selecting one of said single use disposable razor blade cartridge package or said second single use disposable razor blade cartridge package.

16. The method of claim 12, further comprising a third razor handle connectable in use with a razor blade cartridge, said third razor handle configured to provide a third operative effect, different from said first operative effect and the second operative effect, said third razor handle being enclosed in a third single use disposable blister package and arranged at a third position, said third single use disposable blister package enclosing only said third razor handle;
selecting one of said first, said second or said third single use disposable blister package; and,
selecting one of said single use disposable razor blade cartridge package, or said second single use disposable razor blade cartridge package.

17. The method of claim 16, further comprising a third razor blade cartridge in a third single use disposable razor blade cartridge package, and selecting one of said single use disposable razor blade cartridge package, or said second single use disposable razor blade cartridge package or said third single use disposable razor blade cartridge package.
